(19) United States
(12) Patent Application Publication
(10) Pub. No.: US 2007/0115274 A1
(43) Pub. Date: May 24, 2007

(54) Circuit for setting up common voltage and method therefor

(76) Inventor: Chien-Chia Shih, Hsinchu (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/355,597

(22) Filed: Feb. 15, 2006

(30) Foreign Application Priority Data
Nov. 22, 2005 (TW) 94140910

(51) Int. Cl. G09G 5/00

(52) U.S. Cl. 345/211

(57) ABSTRACT

A device for setting up common voltage is provided. The device includes a voltage-dividing circuit, a coupler, a switch and a testing module. The voltage-dividing circuit divides a DC bias according to a voltage-dividing proportion and produces a common voltage for the coupler. The switch determines whether to transfer the output of the coupler to a display panel according to the output of the testing module. The testing module sends a constant voltage to all the data lines in the display panel and fixes the scan signal period and frame switching rate of the display panel to measure the kickback voltage of the display panel. The testing module adjusts the voltage-dividing proportion of the voltage-dividing circuit according to the kickback voltage. When the common voltage level is equal to the kickback voltage level, the testing module turns on the switch to transfer the common voltage level to the display panel.

### CROSS-REFERENCE TO RELATED APPLICATION

This application claims the priority benefit of Taiwan application serial no. 94140910, filed on Nov. 22, 2005. All disclosure of the Taiwan application is incorporated herein by reference.

### BACKGROUND OF THE INVENTION

1. Field of Invention

The present invention relates to a circuit for setting up voltage and the method therefor. More particularly, the present invention relates to a circuit for setting up the common voltage of a display panel and the method therefor.

2. Description of Related Art

A flat display panel generally comprises an active matrix substrate, an opposite substrate, and a liquid crystal layer between the two substrates. Wherein, the active matrix substrate includes a substrate, a plurality of pixel structures arranged in an array on the substrate, a plurality of scan lines, and a plurality of data lines. The foregoing pixel structure mainly comprises a thin film transistor, a pixel electrode, and a storage capacitance. Generally speaking, scan lines and data lines respectively transfer scan signal voltages and data voltages to corresponding pixel structures, so that the liquid crystal display panel can achieve the display function.

In a display panel, each intersection of the scan lines and data lines is disposed with a thin film transistor. Wherein, the source of the thin film transistor is coupled to the corresponding data line, the gate thereof is coupled to the corresponding scan line, and the drain thereof is coupled to a common voltage through a storage capacitance and a pixel electrode connected in parallel.

Generally speaking, when the display panel performs column-wise scanning, the parasitic capacitance Cgd between the gate and the drain of the thin film transistor affects the voltage at the drain, which would suddenly cause the driving voltage of the pixel electrode to drop a voltage level, and the abruptly dropped voltage is called a kickback voltage. The frame quality of the display panel will be affected due to the kickback voltage. In the conventional technology, to reduce the kickback voltage, images are viewed manually to adjust the common voltage level to the kickback voltage level.

However, human's visual perception is different, and the manual adjustment is less efficient, so errors may vary from people to people.

### SUMMARY OF THE INVENTION

Accordingly, the present invention is directed to provide a method for measuring kickback voltage and setting up common voltage, so as to improve efficiency and reduce errors caused by manual adjustment.

The present invention provides a circuit for setting up common voltage and the device is applicable to display panels. According to the present invention, the circuit includes: a voltage-dividing circuit used for receiving a DC bias and dividing the DC bias according to a voltage-dividing proportion to produce a common voltage; a coupler having a positive input terminal receiving the common voltage output by the voltage-dividing circuit and its output terminal and negative input terminal being coupled with each other; a switch determining whether to transfer the common voltage output by the coupler to the display panel according to a control signal; and a testing module transferring a constant voltage to all the data lines in the display panel and fixing the scan signal period and the frame switching ratio of the display panel to measure the kickback voltage of the display panel.

Wherein, the testing module further adjusts the voltage-dividing proportion according to the kickback voltage. When the common voltage level is equal to the kickback voltage level, the testing module produces a control signal to turn on the switch and further to transfer the common voltage to the display panel.

According to another embodiment of the present invention, in the circuit of the present invention, the testing module is a field programmable gate array (FPGA) chip and a display module.

In addition, the voltage-dividing circuit includes: a first resistor having one terminal grounded; a variable resistor having one terminal coupled to the other terminal of the first resistor, and having a central terminal coupled to the other terminal of the variable resistor and to the testing module and the positive input terminal of the coupler; a second resistor having one terminal coupled to the other terminal of the variable resistor and one terminal of the third resistor, and the other terminal of the third resistor receiving DC bias −15V, wherein the testing module determines the resistance of the variable resistor according to the output of the display panel.

In an embodiment of the present invention, the constant voltage may be ground voltage. In addition, the scan signal period of the display panel can be set at 32 μs, and the frame switching ratio of the display panel can be set at 20 ms. Here in the setup circuit of the display panel, the display panel is an active matrix display panel.

According to another aspect of the present invention, a method for setting up common voltage is provided, which is also applicable to display panels. The method includes: first transferring a constant voltage to all the data lines in the display panel, and fixing the scan signal period and the frame switching ratio of the display panel; next, measuring the kickback voltage of the display panel and automatically adjusting the common voltage level to be equal to the kickback voltage level; finally, transferring the adjusted common voltage to the display panel.

In the present invention, the common voltage level can be automatically adjusted to be equal to the kickback voltage level, thus, compared with the conventional technology, the efficiency is improved considerably and the difference due to visual perception is avoided.

In order to make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram illustrating a circuit for setting up common voltage according to an embodiment of the present invention.

FIG. 2 is a flowchart illustrating a method for setting up common voltage according to an embodiment of the present invention.

FIG. 3 is a timing diagram illustrating the timing produced by a timing controller.

### DESCRIPTION OF EMBODIMENTS

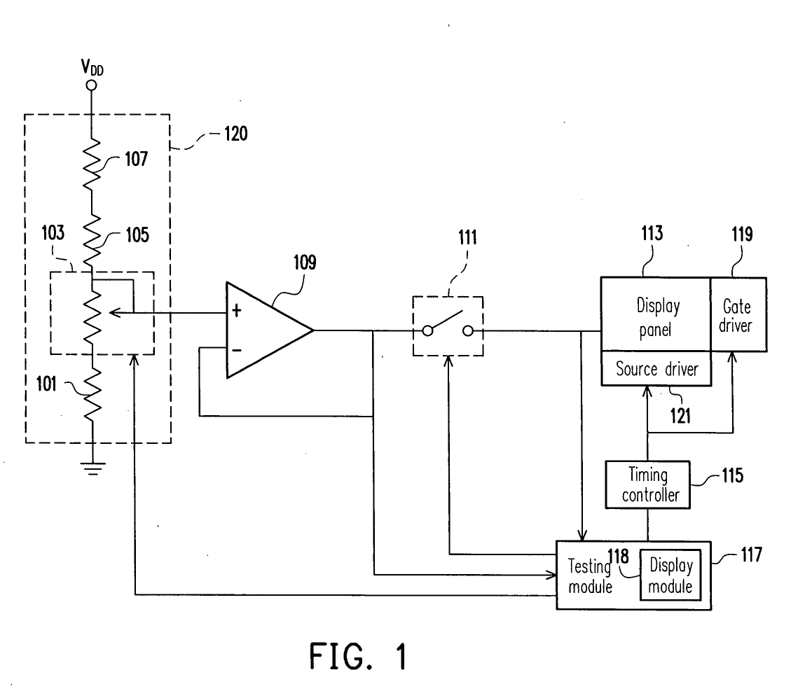

FIG. 1 is a diagram illustrating a circuit for setting up common voltage according to an embodiment of the present invention. Referring to FIG. 1, the circuit of the present invention includes a voltage-dividing circuit 120, a coupler 109, a switch 111, and a testing module 117. Wherein, the voltage-dividing circuit 120 is coupled to the positive input terminal of the coupler 109 and the testing module 117. In addition, the output terminal and the negative input terminal of the coupler 109 are coupled with each other and to the display panel 113 through the switch 111, wherein the switch 111 determines whether to be turned on according to the output of the testing module 117.

In the present embodiment, the voltage-dividing circuit 120 includes a resistor 101, a variable resistor 103, a resistor 105, and a resistor 107. Wherein, one terminal of the resistor 101 is grounded, the other terminal thereof is coupled to one terminal of the variable resistor 103. The variable resistor is coupled to the resistors 101 and 105 respectively, and the variable resistor 103 has a central terminal also coupled to the resistor 105 and the positive input terminal of the coupler 109. Moreover, one terminal of the resistor 105 is coupled to the variable resistor 103, and the other terminal thereof is coupled to a DC bias through the resistor 107. In the present embodiment, the DC bias is −15V.

In the present embodiment, the resistance of the variable resistor 103 is determined by the testing module 117. Thus, the testing module 117 can change the voltage-dividing proportion of the voltage-dividing circuit 120 by adjusting the resistance of the variable resistor 103. Accordingly, the voltage-dividing circuit 120 divides the DC bias based on the voltage-dividing proportion to produce the common voltage required by the common voltage line of the display panel 113, and then transfers the common voltage to the positive input terminal of the coupler 109.

It is known that the display panel 113 has a plurality of scan lines, data lines, and common voltage lines. Wherein, the scan lines are coupled to the gate driver 119, the data lines are coupled to the source driver 121, and the common voltage lines transfer the common voltage to each pixel in the display panel 113. In addition, the operations of the gate driver 119 and the source driver 121 are controlled by the timing controller 115. Wherein, the timing controller 115 controls the gate driver 119 to produce scan signals and the scan signals are respectively transferred to the display panel 113 through the scan lines, and the source driver 121 transfers the data voltage to the corresponding pixel through one of the data lines (not shown) in the display panel 113 according to the output of the timing controller 115. Since the structure of the display panel is not the focus of the present invention, and the driving technology of display panel is known to those with ordinary skill in the art, so they are not described here.

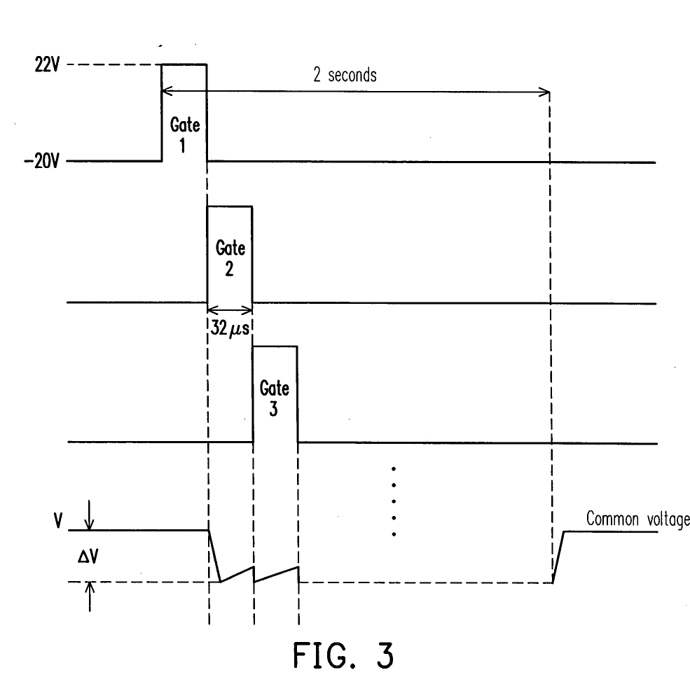

Referring to FIG. 1 again, in the present invention, when the manufacturer is about to adjust the common voltage of the display panel, the testing module 117 can be made to control the timing controller 115 to transfer a constant voltage to all the data lines of the display panel. The constant voltage may be set as 0V, i.e. ground voltage. This is to keep the output of all the data lines as 0V to be transferred to the display panel, and to further keep all the scan lines scanning. Next, the testing module 117 controls the timing controller 115 to fix the scan signal period and frame switching ratio of the display panel 113. For example, as shown in FIG. 3, the scan signal period can be set at 32 μs, and the frame switching ratio can be set at 20 ms.

FIG. 3 is a timing diagram illustrating the timing produced by a timing controller. Referring to both FIG. 1 and FIG. 3, the testing module 117 keeps scanning for 2 seconds after it has completed the foregoing operations, and then a signal for measuring the kickback voltage of the display panel 113 is sent by the display panel 113 to the testing module 117, so as to obtain the kickback voltage level of the display panel 113, as the Δ V shown in FIG. 3. In some selected embodiments, the testing module 117 can be implemented with a field programmable gate array (FPGA). While in the present embodiment, the testing module 117 further includes a display module 118 for displaying the kickback voltage level.

When the testing module 117 has measured the kickback voltage Δ V, it generates a control signal for the voltage-dividing circuit 120 to adjust the resistance of the variable resistor 103, so as to make the common voltage level produced by the voltage-dividing circuit 120 to be equal to the kickback voltage level.

When the testing module 117 detects that the voltage level at the output terminal of the coupler 109 is equal to the kickback voltage, the testing module 117 sends a control signal to the switch 111 to turn on the switch 111, so that the common voltage output by the coupler 109 can be transferred to the common voltage lines of the display panel 113. In the present invention, because the common voltage level is adjusted to be equal to the kickback voltage level, change in the image quality of the display panel 113 can be avoided.

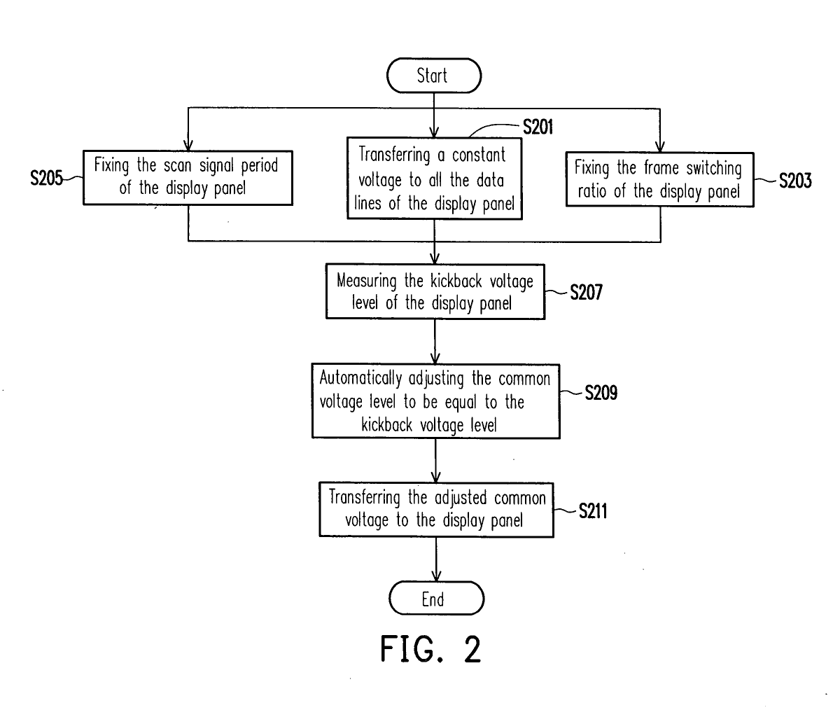

FIG. 2 is a flowchart illustrating a method for setting up common voltage according to an embodiment of the present invention. First, as described in step S201, a constant voltage is transferred to all the data lines of the display panel, and as described in step S203, the scan signal period of the display panel is fixed, and as described in step S205, the frame switching ratio of the display panel is fixed. Next, in step S207, the kickback voltage level of the display panel is measured, then in step S209, the common voltage level is automatically adjusted to be equal to the kickback voltage level. Finally, as described in step S211, the common voltage is transferred to the display panel.

In overview, the present invention provides a device for setting up common voltage and the device is applicable to display panels. Since the device for setting up common voltage provided by the present invention can automatically adjust the common voltage level to be equal to the kickback voltage level, the quality of the displayed images of the display panel can be improved. And since manual correction is not necessary in the present invention, the panel testing efficiency can be improved, and the labor cost can be reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A circuit for setting up common voltage, applicable to display panels, the setup circuit comprising:
a voltage-dividing circuit, receiving a DC bias, dividing the DC bias according to a voltage-dividing proportion to produce the common voltage;
a coupler, having a positive input terminal receiving the common voltage output by the voltage-dividing circuit, an output terminal thereof and negative input terminal thereof being coupled with each other;
a switch, determining whether to transfer the common voltage output by the coupler to the display panel according to a control signal; and
a testing module, transferring a constant voltage to all the data lines in the display panel, fixing the scan signal period and the frame switching ratio of the display panel to measure a kickback voltage of the display panel,
wherein the testing module adjusts the voltage-dividing proportion according to the kickback voltage, and when the common voltage level is equal to the kickback voltage level, the testing module generates a control signal to turn on the switch.

2. The circuit as claimed in claim 1, wherein the testing module is a field programmable gate array (FPGA) chip.

3. The circuit as claimed in claim 1, wherein the testing module includes a display module used for displaying the kickback voltage.

4. The circuit as claimed in claim 1, wherein the voltage-dividing circuit includes:
a first resistor, having one terminal grounded;
a variable resistor, having one terminal coupled to the other terminal of the first resistor, having a central terminal coupled to the other terminal of the variable resistor and to the testing module and the positive input terminal of the coupler;
a second resistor, having one terminal coupled to the other terminal of the variable resistor; and
a third resistor, having one terminal coupled to the other terminal of the second resistor, having the other terminal receiving the DC bias,
wherein the testing module determines the resistance of the variable resistor according to the output of the display panel.

5. The circuit as claimed in claim 1, wherein the constant voltage is ground voltage.

6. The circuit as claimed in claim 1, wherein the testing module sets the scan signal period of the display panel at 32 μs.

7. The circuit as claimed in claim 1, wherein the testing module sets the frame switching ratio of the display panel at 20 ms.

8. The circuit as claimed in claim 1, wherein the display panel is an active matrix display panel.

9. A method for setting up common voltage, applicable to display panels, the setup method comprising:
transferring a constant voltage to all the data lines in the display panel;
fixing a scan signal period of the display panel;
fixing a frame switching ratio of the display panel;
measuring a kickback voltage of the display panel;
adjusting the common voltage level to be equal to the kickback voltage level automatically; and
transferring the adjusted common voltage to the display panel.

10. The method as claimed in claim 9, wherein the step of generating the common voltage comprises:
receiving a DC bias; and
dividing the DC bias according to a voltage-dividing proportion to generate the common voltage.

11. The setup method as claimed in claim 10, wherein the step of adjusting the common voltage level includes adjusting the voltage-dividing proportion.

12. The setup method as claimed in claim 9, wherein the constant voltage is ground voltage.

13. The setup method as claimed in claim 9, wherein the step of fixing the scan signal period of the display panel includes setting the scan signal period of the display panel at 32 μs.

14. The setup method as claimed in claim 9, wherein the step of fixing the frame switching ratio of the display panel includes setting the image switching ratio of the display panel at 20 ms.

15. The setup method as claimed in claim 9, wherein the display panel is an active matrix display panel.
